(19) United States
(12) Patent Application Publication
(10) Pub. No.: US 2012/0119405 A1
(43) Pub. Date: May 17, 2012

(54) DEVICE AND METHOD FOR PRODUCING A COMPOSITE COMPONENT

(75) Inventors: Hans-Juergen Weber, Verden (DE); Gregor Christian Endres, Pfaffenhofen (DE)

(73) Assignees: EADS DEUTSCHLAND GMBH, Ottobrunn (DE); AIRBUS OPERATIONS GMBH, Hamburg (DE)

(21) Appl. No.: 13/296,345

(22) Filed: Nov. 15, 2011

Related U.S. Application Data
(63) Continuation of application No. PCT/EP2010/057124, filed on May 25, 2010.
(60) Provisional application No. 61/181,056, filed on May 26, 2009.

(30) Foreign Application Priority Data
May 25, 2009 (DE) 10 2009 026 456.6

(51) Int. Cl. B29C 70/44; B29C 70/36

(52) U.S. Cl. 264/101; 425/388

(57) ABSTRACT

The present invention provides a device for producing a composite fiber component. The device comprises a shaping tool having a shaping surface for shaping a resin-soaked fiber material, a filter panel that is arranged at the shaping surface and comprises a porous material, and a means for generating a negative pressure at the shaping surface at a side of the filter panel that faces away from the fiber material. In another aspect, the invention provides a method for producing a composite fiber component. First, a filter panel comprising a porous material is provided. In subsequent steps, a resin-soaked fiber material is arranged on the filter panel, the fiber material on the filter panel is covered and a negative pressure is generated at a side of the filter panel that faces away from the fiber material.

### CROSS-REFERENCE TO RELATED APPLICATIONS

This application is a continuation of and claims priority to PCT/EP2010/057124 filed May 25, 2010 which claims the benefit of and priority to U.S. Provisional Application No. 61/181,056, filed May 26, 2009 and German Patent Application No. 10 2009 026 456.6, filed May 25, 2009, the entire disclosures of which are herein incorporated by reference.

### FIELD OF THE INVENTION

The present invention relates to a device for producing a fibre composite component, in particular for an aircraft or spacecraft. The invention also relates to a method for producing a fibre composite component.

Although the present invention and the problem on which it is based can be applied to any fibre composite components, they will be described in detail with respect to fibre composite components for uses in aircraft construction.

Such fibre composite components typically comprise fibres of, for example carbon, aramid and/or glass which in most cases are embedded in a thermosetting polymer matrix. In a conventional production process, fibres which are pre-impregnated with a resin, so-called prepregs, are introduced into a moulding tool shaped in accordance with the component, and the resin is cured under the effect of heat, for example. In other conventional methods, first of all, non-impregnated fibres are arranged in a moulding tool and are impregnated with the resin by feeding liquid resin into the moulding tool. The resin is then cured in the moulding tool.

To prevent the inclusion of air and to prevent pores in the fibre composite component, the fibres are usually enclosed in an air-tight manner in the moulding tool with the uncured resin matrix before curing and are subjected to a vacuum.

The quality of the vacuum through influencing the development of pores is one of the significant decisive factors for the later quality of the component. To produce the air-tight enclosure, vacuum films, silicone membranes or vacuum bags consisting thereof are used, for example.

However, when the space enclosed under such films is evacuated from suitable suction points, the effect occurs, particularly in the case of planarly extended fibre composite components that the films are quickly drawn by suction onto the surface of the component and block further air flows from the component surface to the suction points. This restricts the quality of the vacuum which can be achieved on the component surface, so that the development of pores cannot be adequately prevented.

To allow a flat suction, additional textile aids are usually arranged between the vacuum film and the fibre composite component and are evacuated by the vacuum film. The textile means have to be constructed such that they still allow a flow of air even under increasing vacuum pressure. Since a pure textile layer would greatly reduce the surface quality, perforated pressure sheets and perforated films, inter alia, are arranged in turn as a counter-measure between the textile layer and the fibre composite component. Overall, a complicated structure of numerous layers is thus created during each production of a fibre composite component, which has to be carried out carefully in keeping with the effects on the quality of the fibre composite component and entails high production costs.

### SUMMARY OF THE INVENTION

It is therefore the object of the present invention to allow the production of in particular planarly extended fibre composite components with a high quality and low production costs.

The idea on which the present invention is based is to arrange a filter plate, which comprises a porous material, on a moulding surface of a moulding tool to mould a resin-impregnated fibre material. The device also comprises a means for producing a vacuum on a side of the filter plate remote from the fibre material.

The fact that the material of the filter plate is porous allows the vacuum over the entire surface of the plate acting as a filter to also pass onto the side of the filter plate which faces the fibre material or allows air to be removed by suction in a planar manner in the opposite direction, so that a high-quality vacuum is produced over the entire surface of the fibre material facing the filter plate and pore formation is reliably prevented in the fibre composite component. In this respect, the low deformability inherent in the porous material configured as a plate prevents the material from being compressed under the effect of the vacuum, so that a high dimensional accuracy and surface quality of the fibre composite component are allowed even without perforated sheets, to be additionally inserted, or similar complex measures.

During the use of the device, a resin-impregnated fibre material is arranged on the filter plate, the fibre material is covered in an air-tight manner above the filter plate and a vacuum is produced on the side of the filter plate remote from the fibre material. Since the low deformability of the material of the filter plate allows the filter plate to be arranged in the moulding tool without impairing the dimensional stability of the fibre composite component, it is unnecessary for the filter plate to be arranged anew for the production of each individual fibre composite component. The fact that the vacuum is produced on the side remote from the fibre material also allows the corresponding means to also be set up in a permanent manner, so that they do not have to be constructed anew for each production procedure, which is financially advantageous.

According to a preferred development, the porous material comprises a sintered material. Such a material is characterised by a particularly high inherent stability, so that pores which have formed in the sintered material reliably remain open and a particularly high dimensional stability of the fibre composite component is achieved. The sintered material preferably has a grain size of from 0.2 to 2 mm, to allow on the one hand an unhindered air flow through the filter plate and on the other hand a sufficiently planar surface on the side of the fibre material.

According to a preferred development, the filter plate comprises two layers of the sintered material with different grain sizes. The layer with the larger grain size is arranged on the side remote from the fibre material. As a result, due to a more finely-pored surface on the side of the fibre material, a particularly high surface quality of the fibre composite material is achieved, while larger pores in the layer remote from the fibre material ensure an optimum air permeability of the filter plate.

According to a preferred development, the porous material comprises a metal material, which makes the device particularly robust. Preferred metal materials are, for example, bronze and/or steel due to their particular loading capacity.

According to a preferred development, the filter plate has a thickness of from 1 to 5 mm. This allows a good inherent stability with good air permeability.

According to a preferred development, a membrane is provided which is substantially impermeable to the resin and which covers a side of the filter plate facing the fibre material. This prevents resin from passing out of the resin-impregnated fibre material into pores in the filter plate.

According to a preferred development, a vacuum film or a silicone membrane is also provided for covering the fibre material in an air-tight manner above the filter plate. This is particularly easy to position, because no suction connection pieces or the like have to be attached to the vacuum film or silicone membrane.

According to a preferred development, the device comprises a first feed means for feeding resin into the fibre material at a first feed station and comprises a second feed means for feeding resin into the fibre material at a second feed station. The second feed station is spaced apart from the first feed station in a direction extending along the filter plate. Also provided are a resin detector at a detection station in the region of the second feed station which detects whether resin has reached the detection station, and a control means which activates the second feed station when resin has reached the detection station. This makes it possible to produce particularly large fibre composite components, because during infiltration, the resin only has to cover a path which approximately corresponds to the spacing of the feed stations, irrespective of the size of the component. The detection station is preferably arranged spaced apart from the second feed station in the direction of the first feed station. This ensures that the resin has already reached the second feed station when the control means activates it, so that air is prevented from being included between quantities of resin fed by the two feed stations.

### BRIEF DESCRIPTION OF THE DRAWINGS

In the following, the invention will be described in more detail on the basis of embodiments with reference to the following figures of the drawings, in which:

FIG. 1 is a schematic sectional view of a device for producing a composite component according to an embodiment;

FIG. 2 is a detail sectional view of a filter plate of a device according to an embodiment;

FIG. 3 is a sectional view of an example of a composite component; and

FIG. 4 is a schematic representation of a method and device for producing an aircraft fuselage section according to an embodiment.

### DESCRIPTION OF EXEMPLARY EMBODIMENTS

In the figures, the same reference numerals denote identical or functionally identical components, unless indicated otherwise.

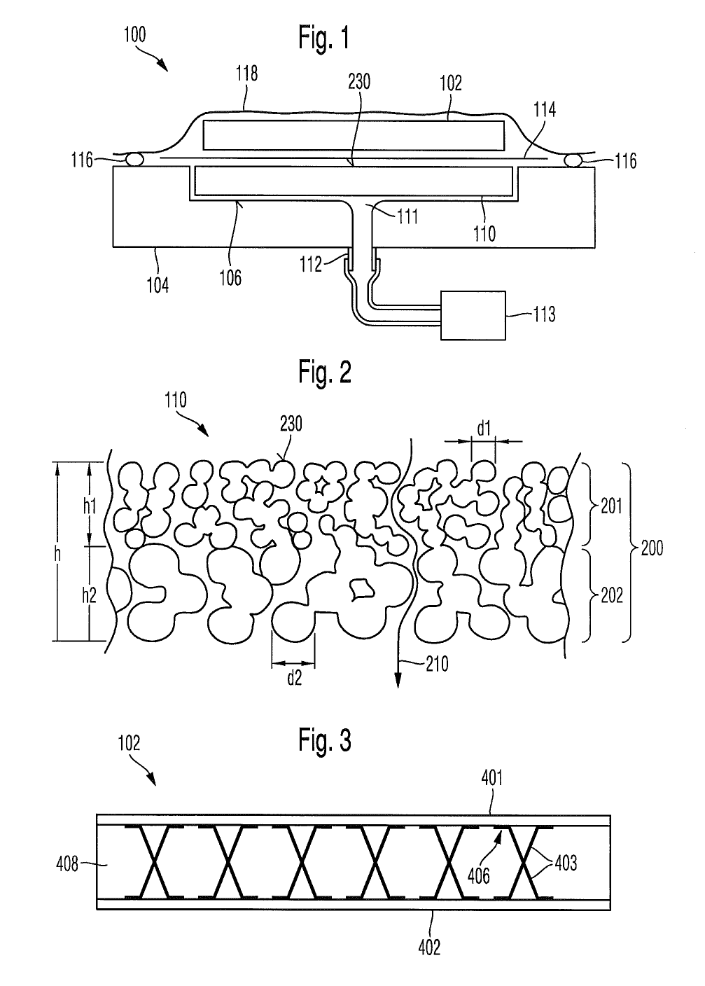

FIG. 1 is a schematic sectional view of a device 100 for producing a composite component 102. A moulding tool 104 of the device 100 has a recess with a moulding surface 106. Formed in the base of the recess, in the moulding surface 106 is a suction opening 111 which passes through the moulding tool 104 and ends in a suction connecting piece 112 configured on a rear side of the moulding tool 104 remote from the moulding surface 106. The suction connecting piece 112 is connected to a vacuum pump 113 by a vacuum tube.

Arranged in the recess in the moulding tool 104 is a filter plate 110 consisting of a porous material, for example a sintered material which is supported in a planar manner by the moulding surface 106 and completely fills the recess in the moulding tool 104. The surface of the filter plate 102 remote from the moulding surface 106 is covered by a semi-permeable membrane 114 which is impermeable to resin but permeable to air, for example a correspondingly impregnated thin textile woven fabric. Arranged on an edge of the moulding tool 104, surrounding the filter plate 110 is a seal 116 which seals a vacuum film 116 in an air-tight manner with the moulding tool 104. A fibre composite component 102 is arranged by way of example between the vacuum film 118 and the filter plate 110 covered by the membrane 114.

During use of the device 100, the fibre composite component 102 is arranged, for example in the form of prepregs over the filter plate 110 in the illustrated manner and covered with the vacuum film 118. The vacuum pump 113 then evacuates the space surrounding the fibre composite component 102 and the fibre composite component 102 is cured, for example by the supply of heat by means of a heating device (not shown). In addition, external pressure can be applied, for example in an autoclave.

FIG. 2 is a detail sectional view of a filter plate 110 of a device, for example of the filter plate 110 of FIG. 1. The filter plate 110 comprises two superimposed first and second layers 201, 202 of a sintered material 200, for example bronze, steel or ceramics. In the first layer 201 which has a thickness h1, a grain size d1 (diameter) is smaller than a grain size d2 in the second layer 202 which has a thickness h2. The grain sizes d1, d2 are, for example in a range of between 0.2 mm and 2 mm, with an overall thickness h of the filter plate 110 of approximately 1 mm to 5 mm.

Grain sizes d1, d2 and thicknesses h1, h2, h are coordinated with one another such that air-permeable pores 210 remain, the filter plate 110 is stable and it has a surface 230 facing the fibre composite component during the intended use.

FIG. 3 is a sectional view of an example of a composite component 102 which can be produced by a device like the one shown in FIG. 1. The composite component 102 comprises a planarly extended core 408 consisting of a foam material, on the opposite, substantially parallel sides of which are configured a first cover layer 401 and a second cover layer 402 consisting of a fibre material. Extending between the first cover layer 401 and the second cover layer 402 are struts 403 consisting of fibre bundles through the core 408, the ends 406 of which struts 403 rest against the cover layers 401, 402. Cover layers 401, 402 and struts 403 are filled with a common polymer matrix which can be fed in the evacuated state, for example with an arrangement in the device from FIG. 1.

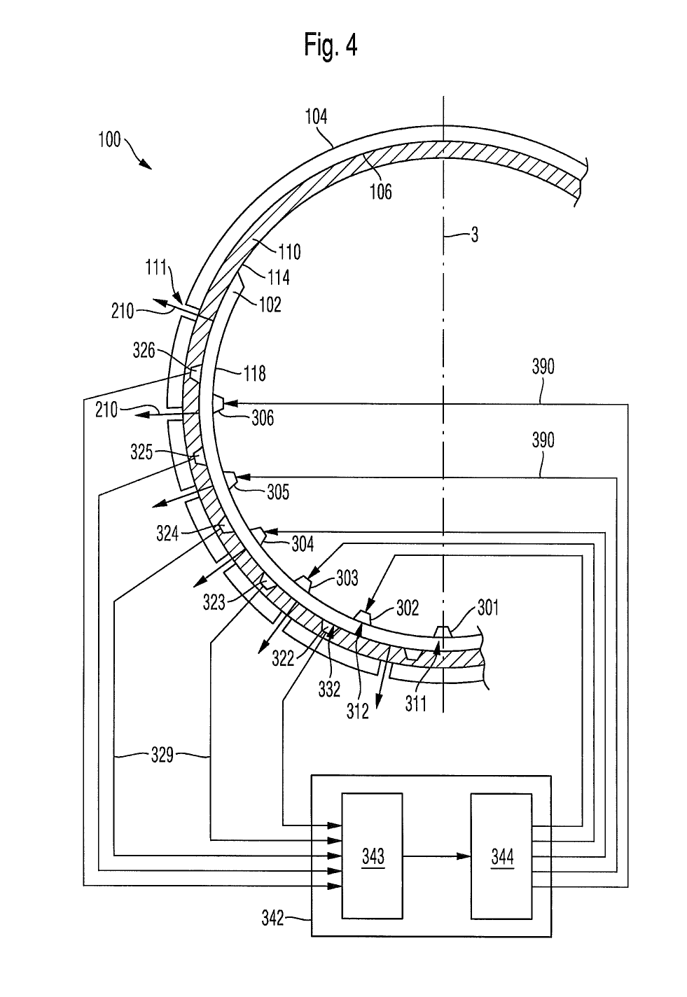

FIG. 4 is a schematic representation of a method and a device for producing a fuselage shell 102 for an aircraft fuselage section in the form of a fibre composite component which has, for example, an internal structure like that shown in FIG. 3.

The device comprises a moulding tool 104 which defines an outer surface of the aircraft fuselage. Attached to the inner moulding surface 106 is a filter plate 110 which is curved in the manner of a cylinder corresponding to the shape of the aircraft fuselage and is supported by the moulding surface 106. Non-impregnated fibre material 102 having a structure as shown in FIG. 3 is arranged on a membrane 114 covering the filter plate 110 and is sealed above the filter plate in an air-tight manner by a vacuum film 118.

Arranged at a first feed station 311 at the lowest point of the moulding tool 104 is a first feed means 301 for feeding resin into the fibre material 102 through the vacuum film 118. Further feed means 302-306 are located upstream of the first feed station 311 along the curvature of the fuselage shell 102 to be produced in approximately regular intervals.

Fitted in the filter plate 110, in each case in the vicinity of one of the second 302 to sixth 306 feed means, are associated resin detectors 332-336 which are slightly offset in each case relative to the associated feed means in a direction away from the first feed station 311. The resin detectors are configured to emit a detection signal via corresponding detector lines 392 if they detect the presence of resin. For example, the resin detectors 332-336 have a suitable recess with a light barrier which visually records penetrating resin.

The detector lines lead to a detection unit 343 of a control means 342 of the device 100, which detection unit 343 evaluates signals received during operation and instructs an activation unit 344 of the control means 342, upon the response of a resin detector 332-336, to activate the respectively associated feed unit 302-306 via corresponding activation lines 390. The resin feed to the rest of the feed means 302-306 can expediently be interrupted at the same time.

Although the present invention has been described above on the basis of preferred embodiments, it is not restricted thereto, but can be modified in many different ways.

For example, the porous material can also consist of a single layer of a uniform grain size, or it can have a large number of different grain sizes mixed together. The porous material can be produced in a different manner to sintering, for example by chemical processes.

In the following preferred embodiments of the device and the method are explained.

1. Device for producing a fibre composite component, comprising:

a moulding tool with a moulding surface for moulding a resin-impregnated fibre material;

a filter plate which is arranged on the moulding surface and comprises a porous material; and

a means for producing a vacuum on the moulding surface on a side of the filter plate remote from the fibre material.

2. Device according to embodiment 1, characterised in that the porous material comprises a sintered material.

3. Device according to embodiment 2, characterised in that the sintered material has a grain size of from 0.2 to 2 mm.

4. Device according to embodiment 2 or 3, characterised in that the filter plate comprises two layers of the sintered material with different grain sizes, the layer with the larger grain size being arranged on the side remote from the fibre material.

5. Device according to any one of the preceding embodiments, characterised in that the porous material comprises a metal material, in particular bronze and/or steel.

6. Device according to any one of the preceding embodiments, characterised in that the filter plate has a thickness of from 1 to 5 mm.

7. Device according to any one of the preceding embodiments, characterised by a membrane which is substantially impermeable to the resin and covers a side of the filter plate facing the fibre material.

8. Device according to any one of the preceding embodiments, characterised by a vacuum film or silicone membrane for covering the fibre material in an airtight manner above the filter plate.

9. Device according to any one of the preceding embodiments, characterised by

a first feed means for feeding resin into the fibre material at a first feed station;

a second feed means for feeding resin into the fibre material at a second feed station which is spaced apart from the first feed station along the filter plate;

a resin detector at a detection station in the region of the second feed station, which detects whether resin has reached the detection station; and

a control means which activates the second feed means when resin has reached the detection station.

10. Device according to embodiment 9, characterised in that the detection station is arranged spaced apart from the second feed station in a direction of the first feed station.

11. Method for producing a fibre composite component, comprising the following steps:

providing a filter plate which comprises a porous material;

arranging a fibre material impregnated with resin on the filter plate;

covering the fibre material in an air-tight manner above the filter plate; and

producing a vacuum on a side of the filter plate remote from the fibre material.

12. Method according to embodiment 11, characterised by a step of covering the filter plate on a side facing the fibre material with a membrane which is substantially impermeable to the resin.

13. Method according to embodiment 11 or 12, characterised by a step of supporting the filter plate, on the side remote from the fibre material, by a moulding tool.

14. Method according to embodiment 13, characterised in that the vacuum is produced by a suction opening configured in the moulding tool.

15. Method according to any one of embodiments 11 to 14, characterised in that the step of arranging the resin-impregnated fibre material comprises:

arranging the fibre material on the filter plate;

feeding the resin to the fibre material at a first feed station;

detecting, at a detection station on the fibre material, whether the resin has reached the detection station; and

feeding the resin to the fibre material at a second feed station when the resin has reached the detection station.

### LIST OF REFERENCE NUMERALS

100 production device

102 fibre composite component

104 moulding tool

106 moulding surface

110 filter plate

111 suction opening

112 suction connecting piece

113 vacuum pump

114 membrane

116 seal

118 vacuum film

200 sintered material

201, 202 layer

210 air flow

301-306 feed means

311, 312 feed station

322-326 resin detector

332 detection station

342 control means

343 detection unit

344 activation unit

390 activation line

392 detection line

401, 402 cover layer

403 strut

406 bracing

408 foam material

d1, d2 grain size

h1, h2 individual layer thickness

h overall thickness

1. A device for producing a fibre composite component, comprising:
a filter plate which comprises a porous material, with a surface for arranging a resin-impregnated fibre material:
an air-permeable and substantially resin-impermeable membrane which covers the surface of the filter plate facing the fibre material;
a moulding tool for supporting the filter plate on the side remote from the fibre material; and
a suction opening configured in the moulding tool for producing a vacuum on the side of the filter plate remote from the fibre material.

2. The device according to claim 1, wherein the membrane comprises an impregnated textile woven fabric.

3. The device according to claim 1, wherein the porous material comprises a sintered material.

4. The device according to claim 3, wherein the sintered material has a grain size of from 0.2 mm to 2 mm.

5. The device according to claim 3, wherein the filter plate has two layers of the sintered material with different grain sizes, the layer with the larger grain size being arranged on the side remote from the fibre material.

6. The device according to claim 1, wherein the porous material comprises a metal material, in particular bronze and/or steel.

7. The device according to claim 1, wherein the filter plate has a thickness of from 1 mm to 5 mm.

8. The device according to claim 1, wherein a vacuum film or silicone membrane for covering the fibre material in an air-tight manner above the filter plate is provided.

9. The device according to claim 1, wherein the device comprises a first feed means for feeding resin into the fibre material at a first feed station;
a second feed means for feeding resin into the fibre material at a second feed station which is spaced apart from the first feed station along the filter plate;
a resin detector at a detection station in the region of the second feed station, which detects whether resin has reached the detection station; and
a control means which activates the second feed means when resin has reached the detection station.

10. The device according to claim 9, wherein the detection station is arranged spaced apart from the second feed station in a direction away from the first feed station.

11. A method for producing a fibre composite component, comprising the following steps:
providing a filter plate which comprises a porous material;
arranging a fibre material impregnated with resin on a surface of the filter plate;
covering the surface of the filter plate facing the fibre material with a membrane which is permeable to air and substantially impermeable to the resin;
covering the fibre material in an air-tight manner above the filter plate;
supporting the filter plate, on the side remote from the fibre material, by a moulding tool; and
producing a vacuum on a side of the filter plate remote from the fibre material, by a suction opening configured in the moulding tool.

12. The method according to claim 11, wherein the step of arranging the resin-impregnated fibre material comprises:
arranging the fibre material on the filter plate;
feeding the resin to the fibre material at a first feed station;
detecting, at a detection station on the fibre material, whether the resin has reached the detection station; and
feeding the resin to the fibre material at a second feed station when the resin has reached the detection station.
